(19) United States
(12) Patent Application Publication
(10) Pub. No.: US 2021/0114433 A1
(43) Pub. Date: Apr. 22, 2021

(54) MOTOR VEHICLE THERMAL MANAGEMENT SYSTEM

(71) Applicant: Valeo Systemes Thermiques, Le Mesnil Saint Denis (FR)

(72) Inventor: Daniel Neveu, Le Mesnil Saint Denis (FR)

(73) Assignee: Valeo Systemes Thermiques, Le Mesnil Saint Denis (FR)

(21) Appl. No.: 16/970,843

(22) PCT Filed: Feb. 19, 2019
(86) PCT No.: PCT/FR2019/050375

§ 371 Date: Aug. 18, 2020

(30) Foreign Application Priority Data
Feb. 19, 2018 (FR) 1851376

(51) Int. Cl. B60H 1/00

(52) U.S. Cl. CPC B60H 1/00742; B60H 1/00828

(57) ABSTRACT

The invention relates to a thermal management system for a motor-vehicle passenger compartment, this system comprising an air-conditioning device comprising at least one outlet for heat-treated air, this air-conditioning device especially comprising a HVAC, and this system furthermore comprising a control unit arranged to:
acquire a first datum (Clo) representative of the clothing level of a passenger in the passenger compartment and/or a second datum (MET) representative of the metabolic activity of the passenger,
acquire a parameter relative to a thermal-comfort state, this parameter possibly taking at least two extreme values, one of the values being associated with a calm state and the other of the values being associated with a dynamic state,
manage the air-conditioning device to deliver treated air with a flow rate that is dependent on this parameter, this flow rate being, for a given clothing level and/or level of metabolic activity, lower in the case where the parameter is associated with a calm state and higher in the case where the parameter is associated with a dynamic state.

The invention relates to a motor-vehicle thermal management system. The invention further relates to a thermal management method implemented by such a thermal management system.

In a motor vehicle, it is known to provide for management of flow rates, temperatures and distribution of air blown by the various fans depending on outside temperature and insolation conditions. In certain vehicles, this may be combined with the activation of a heated steering wheel and/or a heated or cooled seat, and sometimes with surfaces, such as an elbow rest, that heat via contact.

It is almost unknown to detect and/or take into account the thermal state of passengers, with the exception of a few examples of use of infrared sensors that detect the surface temperature of the clothes of the passengers in order to better take into account initial conditions during the temporary welcome phase (whether the person is entering from a cold or hot environment) and the thermal equilibrium resulting from radiative and convective exchanges. In general, measurement of the thermal state of the passenger compartment is limited to a measurement of air temperatures combined with an insolation sensor.

More sophisticated approaches to comfort management have been proposed, these being based on new sensors, in particular infrared cameras, and new actuators, in particular radiant panels and/or actuators allowing localized air delivery.

In addition, the management of thermal comfort and of the well-being of the one or more passengers in a vehicle must respond to changes to mobility (electrification, automation, sharing, connectivity) and the desire to rationalize as much as possible comfort-related power consumption, in particular in electric vehicles.

Changes to mobility, in particular semi-autonomous/autonomous vehicles, and the development of car sharing practices are modifying the expectations of users in terms of comfort. Vehicles are no longer solely a means of transport in which users are in a state of expectancy and constrained by requirements related to road traffic. Vehicles are becoming a living space or a place of transition, and expectations in respect of on-board comfort and well-being are increasing.

It is already known to provide for management of flow rates, temperatures and distribution of air blown by the various fans of an air-conditioning device, depending on outside temperature and insolation conditions. In certain vehicles, this may be combined with the activation of a heated steering wheel and/or a heated or cooled seat, and sometimes with surfaces (elbow rest, etc.) that heat via contact.

In general, measurement of the thermal state of the passenger compartment is limited to a measurement of air temperatures combined with an insolation sensor.

Patent application WO2017041921 describes a motor-vehicle thermal management system comprising a sensor able to measure at least one quantity usable to determine at least one thermal-comfort datum, and a predefined number of actuators respectively configured to adjust at least one parameter of a piece of equipment of the vehicle.

Known control panels that define interfaces for adjusting thermal comfort vary enormously in terms of style, design, ergonomics, colors and materials, depending on the manufacturer and vehicle, but they are all organized around 4 key functions:
the adjustment of a temperature level, expressed on a qualitative scale (blue/red) or in degrees ° C. (or F.),
the adjustment of a level of airflow, in general expressed in levels from 0 to 4 or 5,
the adjustment of the mode of diffusion of the air, in general 5 modes are proposed: “All Aeration” (air to the top of the passengers—chest and face—), “All Feet” (air to the footwell), “All Defrost” (air to the windshield), “Feet—Defrpst” (air to the footwell and windshield), “Feet-Ventilation” (air to the footwell and top of the passengers),
the adjustment of the rate of air renewal, generally with 2 possible positions: new air or recirculated air.

There is a need to provide vehicles with the ability to adapt to the needs of each user and to various use contexts.

The applicant has observed that the conventional interfaces of the air-conditioning device are not directly centered on the needs or sensations of the user but on the management of the actuators. For example, adjustment of a passenger-compartment temperature to 21° C. is spoken of while the temperature of the blown air may be hot in winter and cold in summer and while references that would allow it to be known whether it would be better to request 21° C. or 23° C. are lacking. Likewise, many people complain of the discomfort caused by currents of air over their face but are unable to determine whether it would be better to firstly adjust the airflow or the choice and orientations of the fans to decrease it. The state of the user at the moment in question, such as his clothing or his energetic activity (for example is he returning from a jog?) are also not taken into account. There follows the need to imagine a new interface that is more centered on the want for thermal sensations (gentler/more aggressive) and on the account to be taken of the state of the user in the use context.

One subject of the invention is therefore a thermal management system for a motor-vehicle passenger compartment, this system comprising an air-conditioning device comprising at least one outlet for heat-treated air, this air-conditioning device especially comprising a HVAC, and this system furthermore comprising a control unit arranged to:
acquire a first datum (Clo) representative of the clothing level of a passenger in the passenger compartment and/or a second datum (MET) representative of the metabolic activity of the passenger,
acquire a parameter relative to a thermal-comfort state, this parameter possibly taking at least two extreme values, one of the values being associated with a calm state and the other of the values being associated with a dynamic state,
manage the air-conditioning device to deliver treated air with a flow rate that is dependent on this parameter, this flow rate being, for a given clothing level and/or level of metabolic activity, lower in the case where the parameter is associated with a calm state and higher in the case where the parameter is associated with a dynamic state.

The invention allows not only a usage that is more intuitive, but also one that is easier and more rich, with a view to achieving:
a better understanding by the vehicle of the expectations and needs of the users, whether this be from their personal profile, their preferences or a specific use context,
a better understanding by the users of the operating modes, options and adjustments proposed by the vehicle to ensure their comfort

These two approaches are complementary and address improvement of the communication and richness of exchanges between the vehicle and users with a view to ensuring their comfort.

The invention allows a rupture with conventional control panels based on the choice and control of a passenger-compartment temperature, of a ventilation level, and of a distribution mode, as described above.

According to one aspect of the invention, the system is arranged to allow the temperature level generated by various actuators of the air-conditioning device to be automatically adjusted, machine learning and/or gradual calibration of the profile and preferences of the user being employed to this end.

According to one aspect of the invention, the system does not permit direct adjustment, by a passenger, of a ventilation level and of an air-distribution mode. The interface does not permit direct adjustment of a ventilation level and of an air-distribution mode).

According to one aspect of the invention, the system is arranged to determine a type of air distribution and the ventilation level provided by the air-conditioning device, especially depending on the use context, on the state of the passenger and on the ambient temperature.

According to one aspect of the invention, the system is arranged so that the first datum (Clo) representative of the clothing level of a passenger in the passenger compartment and/or the second datum (MET) representative of the metabolic activity of the passenger are used to set thermal want in light of the current state of the passenger (i.e. for example whether he is experiencing a physical or cognitive stress). These two data combined with the choice of a thermal-comfort state, or comfort style, are arranged to allow the temperature level generated by various actuators of the air-conditioning device, especially one or more radiant panels and/or the air treated by the HVAC, to be automatically adjusted, machine learning and gradual calibration of the profile and preferences of the user being employed to this end.

According to one aspect of the invention, the system does not permit direct adjustment, by a passenger, of a target temperature when the profile and preferences of the user are known.

According to one aspect of the invention, the system is arranged to store in memory and/or acquire at least one of the following elements:
a user profile,
at least one contextual element such as the first datum (Clo) representative of the clothing level of a passenger in the passenger compartment and/or the second datum (MET) representative of the metabolic activity of the passenger,
a parameter representative of a thermal-comfort state.

According to one aspect of the invention, the system comprises a member for adjusting the heat felt by the passenger, especially of “Colder/Hotter” type, in order to allow the user, by requesting more or less felt heat via this adjusting member, to contribute to the machine learning or, for an occasional user, this adjusting member especially being connected to the control device.

According to one aspect of the invention, the system does not permit direct adjustment, by a passenger, of the rate of air renewal, which is automatically managed depending on the context, and especially depending on information relating to the risk of pollution, the humidity in the passenger compartment and, where appropriate, except via the possible activation at any time of a “demisting and/or defrosting” mode, which corresponds to a safety function. Access to control and adjustment of the degree of humidity will possibly be proposed as an option.

According to one aspect of the invention, the system is arranged to control sensors and/or actuators used to ensure the comfort of the one or more passengers in the vehicle, on the basis of the following parameters:
the parameter related to comfort state, which is tailored to the one or more passengers,
a first datum (Clo) representative of the clothing level of a passenger in the passenger compartment and/or a second datum (MET) representative of the metabolic activity of the passenger,
at least one parameter representative of the profile of the passenger.

According to one aspect of the invention, the system is arranged so that the above parameters are freely selectable by the user, depending on his preferences or the context of use of the vehicle, or are automatically proposed by the comfort-control system, via knowledge of the user profile, learning of his habits or preferences, or processing of information delivered by sensors.

According to one aspect of the invention, the system is arranged to automatically control the above parameters while allowing the user, at any time, to modify one or more of these parameters, whether to indicate to the system an error in the evaluation of the thermal state of the person (for example his clothing and/or his metabolism) and/or an error in the evaluation of his want for thermal comfort (for example the comfort style, the potential correction of the temperature level once the thermal state is known).

According to one aspect of the invention, the comfort-control device is arranged to enrich and/or update a knowledge base, depending on modifications made by the passenger, with a learning software package aiming to improve the detection or prediction of the state and of the expectations of the passenger in the course of future uses of the control device.

According to one aspect of the invention, the control device is capable of detecting or predicting the state and/or the want of each passenger using a personalized model specific to each passenger.

According to one aspect of the invention, the comfort state or comfort style (“calm/dynamic” especially) corresponds to the importance assigned to the use of air to manage thermal comfort and to create thermal sensations.

According to one aspect of the invention, in winter, a comfort of “calm” type is associated with increased use of radiative heating (higher radiant-panel temperatures) and a decreased use of convective heating (decreased air flow rates and/or temperature). In contrast, a “dynamic” comfort is associated with an increased use of hot air, firstly to the feet and to the chest and face in “very dynamic” mode for example.

According to one aspect of the invention, in summer, a comfort of “calm” type is associated with a decreased use of air speeds in the vicinity of the body of the passenger, this being achieved by privileging air outlets of “feet” and/or “defrost” type. A “dynamic” comfort is associated with an increase in the air speeds perceived by the body and in particular by the chest and face, this especially being achieved by prioritizing dashboard fans, and preferably, in “highly dynamic” mode, by using ventilation nozzles in the pillars.

According to one aspect of the invention, the datum with respect to clothing level and metabolic state is enough to determine the temperature to be achieved by the various actuators (air temperature, radiant panels, etc.), provided that the profile and preferences of the person have been apprised.

According to one aspect of the invention, the system is arranged to allow the passenger to choose a “hotter/colder” temperature preference with respect to the automatically proposed adjustments. This adjustment is considered to be optional, because this adjustment is used only in learning mode or by an occasional user, the profile of whom is unknown. In particular, access to this adjustment is not a substitute for the automatic account that is taken of the state of the user.

The temperature preference may especially be expressed in values of: −2° C./+1° C. etc., or qualitatively: “definitely colder”, “colder”, “slightly colder”, “slightly hotter”, etc. with an adjustment limited to a small set of values, typically −3/+3.

According to one aspect of the invention, the default adjustment, which is especially a neutral adjustment, corresponds to the average expectations estimated for the targeted user group, depending on climatic conditions and on the comfort style and state of the users.

According to one aspect of the invention, the system is arranged to generate information representative of the confidence level attributed to the knowledge bases and/or models used to evaluate the state and the thermal want of the user.

According to one aspect of the invention, this information representative of the confidence level is generated in the form of the display of an icon or any other graphical or text element, or any other communication element.

According to one aspect of the invention, this information representative of the confidence level is arranged to establish a dialog between the vehicle and passenger, in order to show both:
the ability of the control system to identify and propose comfort-management options that will become enriched via a learning process in the course of use,
the need and ability of the system to learn and improve by virtue of user feedback and requests.

This information representative of the confidence level may be of two sorts, as follows:

the system highlights that it thinks that a specific thermal want or state has been detected and is in a position to provide the passenger with a solution,
the system lacks information and requests the passenger to apprise or confirm certain parameters.

According to one exemplary embodiment of the invention, the system is arranged to generate:
an activation element for activating at least one automatic comfort-management mode. It is possible to provide two automatic comfort-management modes, one privileging comfort without compromise, the other privileging a decrease in power consumption.

According to one exemplary embodiment of the invention, as soon as the user modifies at least one of the parameters, the system switches to “manual” management mode until the activation of one of the automatic modes is again triggered.

According to one exemplary embodiment of the invention, the system is arranged to generate:
an actuation element for actuating a safety mode for demisting and defrosting the windshield,
where appropriate, a second activation element for managing the degree of humidity in the passenger compartment,
the display of key information apprising of the comfort-management configuration, with, non-exhaustively:

the identity of the person or of the user profile with which the current comfort-management model is associated. This identity will be possible be automatically recognized or selected/modified if required,

exterior ambient temperature,

the temperature perceived by the user, which is a fictional temperature computed from measured real temperature differences and which characterizes the overall equivalent temperature of an environment (air and walls) that would give the same average thermal sensation in calm air,

the power consumption induced by the comfort-management configuration, which may advantageously be expressed in two ways:
the operating range lost with respect to a reference operating range, for example the WLTC operating range, or the operating range induced in this reference cycle,
a color code, or any other graphical or textual element, that expresses whether the configuration and choices of the comfort parameters are eco-responsible, or in other words whether they allow power consumption to be minimized without substantially degrading comfort. For example, in winter, the fact of being warmly clothed and favoring radiative comfort will be positively appraised. In summer, a light outfit and the use of the dynamic mode with nozzles nearby will also be positively appraised.

In both cases, the display modalities and choices aim to raise user awareness of the consequences of their choices on the consumption and the operating range of the vehicle, in a neutral and constant reference system that allows the consequences of the climatic conditions and comfort options to be better appreciated.

Yet another subject of the invention is a device for interfacing between a thermal management system such as described above an a passenger of the vehicle, this interfacing device comprising:
an adjusting member, especially a touch button, arranged to permit the passenger to adjust the first datum (Clo) representative of the clothing level of a passenger in the passenger compartment and/or a second datum (MET) representative of the metabolic activity of the passenger,
a member for adjusting the parameter relative to a thermal-comfort state.

Yet another subject of the invention is a device for interfacing between a thermal management system arranged to manage and control the interactions between a passenger and the thermal management system of a motor vehicle, this device being arranged to:

allow the user to be informed of various information items describing the configuration, the state and the operating parameters of the thermal-comfort management system,
allow the user to configure, parameterize and activate various functions of the thermal-comfort management system,
allow at least three parameters defining the configuration and the adjustment of the thermal-comfort management system to be adjusted for an identified person, namely:
   a parameter relating to the choice of a style of thermal comfort, of the type “gentler” or “more dynamic”
   two parameters relating to the description of the state of the user:
      a clothing level
      a level of metabolic activity

Yet another subject of the invention is a thermal management method for a motor-vehicle passenger compartment, using an air-conditioning device comprising at least one outlet for heat-treated air, this air-conditioning device especially comprising a HVAC, and this method comprising the following steps:
acquiring a first datum (Clo) representative of the clothing level of a passenger in the passenger compartment and/or a second datum (MET) representative of the metabolic activity of the passenger;
acquiring a parameter relative to a thermal-comfort state; this parameter possibly taking at least two extreme values, one of the values being associated with a calm state and the other of the values being associated with a dynamic state;
managing the air-conditioning device to deliver treated air with a flow rate that is dependent on this parameter, this flow rate being, for a given clothing level and/or level of metabolic activity; lower in the case where the parameter is associated with a calm state and higher in the case where the parameter is associated with a dynamic state.

According to one aspect of the invention, the system comprises at least one sensor arranged to measure a parameter serving to determine at least one of the data.

According to one aspect of the invention, the sensor is chosen from:
a camera, especially a DMS camera, arranged to observe a passenger in the passenger compartment,
an infrared dome formed by a wide-angle infrared camera placed on a roof of the passenger compartment and that allows the temperatures of the walls and windows of the passenger compartment to be measured,
an insolation sensor,
a sensor of the temperature at the outlet of an air-conditioning device or of an HVAC after the exchangers,
a sensor of the temperature of the passenger compartment.

A DMS (acronym of Driver Monitoring System) camera is a camera that operates in the near infrared and that may allow an image of the face and/or chest of the driver to be collected, irrespectively of the light level in the passenger compartment. By virtue of algorithms, and especially via physical analysis or the use of big data, it is possible to deduce much information such as: recognition of the identity of the passenger, evaluation of tiredness level, estimation of heart rate, recognition of items of clothing worn on the top part of the body.

According to one aspect of the invention, the system comprises an air-conditioning device, especially a HVAC, and the system is arranged to measure a parameter serving to determine the third datum representative of the thermal environment of the passenger in the passenger compartment, this parameter being related to the state of the air-conditioning device, and especially to the power of a blower of the air-conditioning device or the distribution of conditioned air from the air-conditioning device.

According to one aspect of the invention, the first datum (Clo) representative of the clothing level of the passenger in the passenger compartment corresponds to a thermal resistance of the clothes worn by the passenger.

According to one aspect of the invention, the system is arranged to process an image taken by a camera and, from this image, to determine the type of clothes (T-shirt and/or shirt and/or pullover and/or overcoat and/or scarf and/or hat) worn by the passenger especially via image recognition, the system furthermore being arranged to determine thermal resistance from the type of clothes thus measured.

According to one aspect of the invention, the second datum (MET) representative of the metabolic activity of the passenger is dependent at least on a heart rate of the passenger, which is measured by a camera of the system and especially a DMS camera.

According to one aspect of the invention, this camera is arranged to observe changes in the color of the face of the passenger due to the movement of blood under the skin of the face, and the system measures heart rate based on these images.

According to one aspect of the invention, the second datum (MET) representative of the metabolic activity of the passenger is dependent at least on a physical characteristic of the passenger, which is measured by a camera of the system and especially a DMS camera.

According to one aspect of the invention, the camera is arranged to measure, especially via image processing, physical characteristics of the passenger and especially his sex, age, height and volume. It is possible to deduce weight therefrom.

According to one aspect of the invention, the second datum (MET) representative of the metabolic activity of the passenger is dependent at least on a heart rate of the passenger and at least on one physical characteristic of the passenger.

According to one aspect of the invention, the second datum (MET) representative of the metabolic activity of the passenger corresponds to a thermal power per unit area produced by the passenger.

According to one aspect of the invention, the system is arranged, from the temperatures of the walls and/or windows measured by a sensor, especially an infrared dome, to compute the radiative temperature for at least one part, and especially a plurality of parts, of the body of the passenger, such as his head, chest, back, legs, calves, feet, and/or arms.

According to one aspect of the invention, the computation is carried out for at least six different body parts, and especially at least ten different body parts such as the head, neck, torso, arms, hands, back, bottom, thighs, legs and feet.

According to one aspect of the invention, the system is arranged to estimate the temperature of the air making contact with a part of the body of the passenger, and especially a plurality of parts of the body of the passenger, especially his head, chest, back, legs, calves, feet, and/or arms, especially based on the power of an air blower and/or of the distribution of the HVAC and/or of the temperature of the blown air and of the temperature of the passenger compartment, especially on the basis of charts.

According to one aspect of the invention, the system is arranged, on the basis of the HVAC distribution and/or of the power of the air blower, to estimate, especially using charts, the speed of the air making contact with one part or a plurality of parts of the body of the passenger.

According to one aspect of the invention, the system is arranged to acquire characteristics of the HVAC, such as the positions of the shutters and a characteristic of the blower, with a view to estimating the air speed about the passengers.

According to one aspect of the invention, these temperatures and/or speeds are used to compute the third datum representative of the thermal environment of the passenger in the passenger compartment.

According to one aspect of the invention, the system is arranged to estimate the total thermal power (P_tot_theoretical) exchanged by the passenger with his environment by estimating the thermal power exchanged by each part of his body, especially his head, chest, back, legs, calves, feet and arms.

According to one aspect of the invention, the exchanged powers are dependent on the local air speed, on the local air temperature, on the local radiative temperature, on the area of the passengers, on the clothing level (Clo) of the passenger, and on the second datum (MET) representative of the metabolic activity of the passenger.

According to one aspect of the invention, the system is arranged to compare the total thermal power (P_tot_theoretical) exchanged with the environment with the theoretical power generated by the metabolism of the passengers, and, by multiplying this power difference by a coefficient, to determine a value of the thermal comfort index (PMV).

According to one aspect of the invention, this model can then be used to estimate the instantaneous comfort of the passengers. Set points may also be defined for the thermal actuators in order to ensure passenger comfort. Adjustment of the thermal system is thus personalized.

Contrary to known adjustments, which are based exclusively on parameters extraneous to the passengers (cab temperature, outside temperature, insolation), the invention preferably uses both external data and passenger characteristics. This enables thermal requirement to be refined to ensure thermal comfort for the passengers.

The invention will be better understood and other details, features and advantages of the invention will become apparent on reading the following description, which is given by way of non-limiting example with reference to the appended drawings, in which:

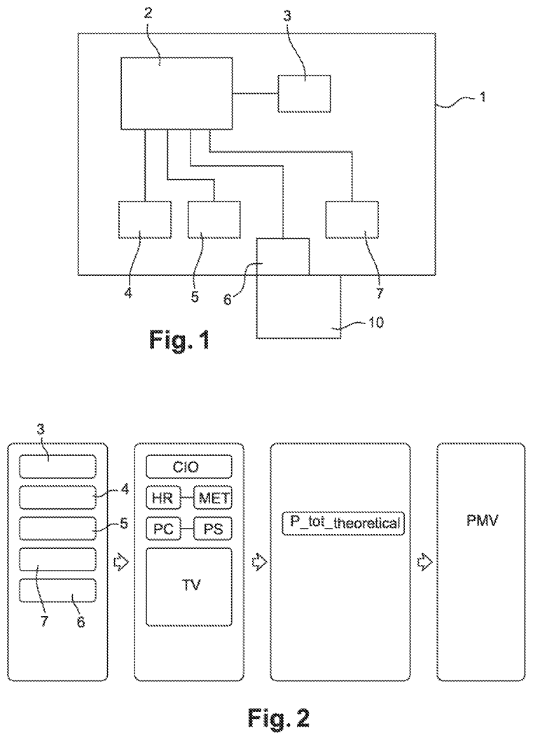

FIG. 1 schematically and partially illustrates a thermal system according to the invention,

FIG. 2 illustrates steps of the method for managing thermal comfort in the system of FIG. 1,

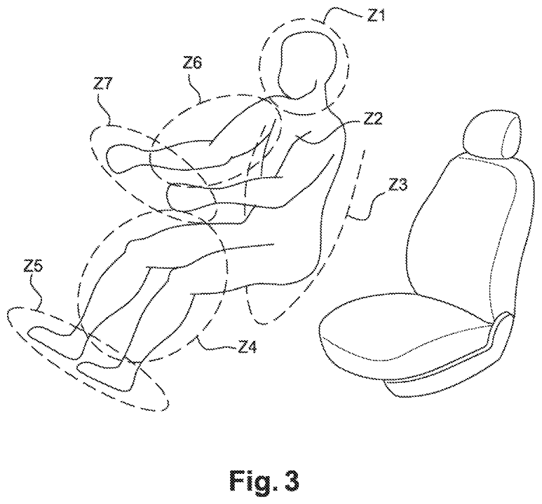

FIG. 3 shows the various regions of the passenger that are involved in the method of FIG. 2,

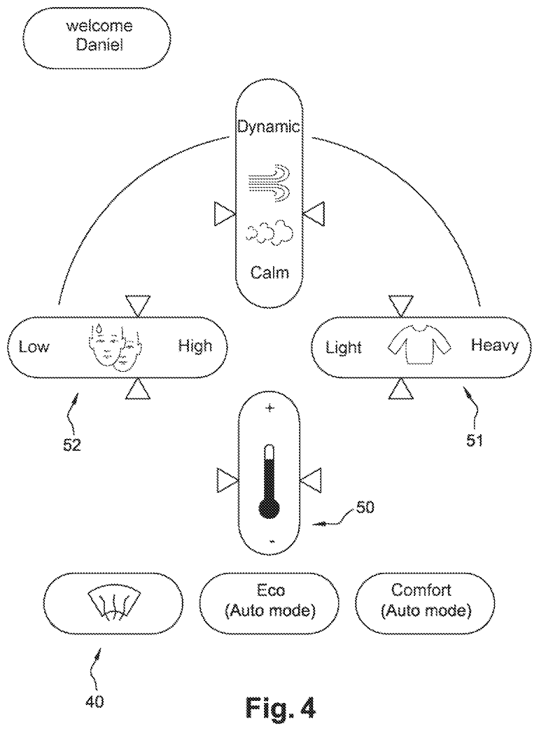

FIG. 4 schematically and partially illustrates an interfacing device according to the invention.

FIG. 1 shows a thermal management system 1 for a motor-vehicle passenger compartment, this system comprising a control unit 2 arranged to:
acquire a first datum (Clo) representative of the clothing level of a passenger in the passenger compartment,
acquire a second datum (MET) representative of the metabolic activity of the passenger,
acquire a third datum representative of the thermal environment of the passenger in the passenger compartment,
determine a value of a thermal comfort index (PMV) associated with the passenger in the passenger compartment on the basis of the three data thus acquired.

The system comprises a plurality of sensors arranged to measure a plurality of parameters serving to determine the first, second and third data.

These sensors comprise:
a DMS camera 3 arranged to observe a passenger in the passenger compartment,
an infrared dome 4 formed by a wide-angle infrared camera placed on a roof of the passenger compartment and that allows the temperatures of the walls and windows of the passenger compartment to be measured,
an insolation sensor 5,
a sensor of the temperature 6 at the outlet of an air-conditioning device or of the HVAC 10,
a sensor of the temperature 7 of the passenger compartment.

The system 1 is arranged to measure a parameter serving to determine the third datum representative of the thermal environment of the passenger in the passenger compartment, this parameter being related to the state of the air-conditioning device, and especially to the power of a blower of the air-conditioning device or the distribution of conditioned air from the air-conditioning device.

The first datum (Clo) representative of the clothing level of the passenger in the passenger compartment corresponds to a measured thermal resistance of the clothes worn by the passenger.

To this end, the system 1 is arranged to process an image taken by the camera 3 and, from this image, to determine the type of clothes (T-shirt and/or shirt and/or pullover and/or overcoat and/or scarf and/or hat) worn by the passenger especially via image recognition, the system 1 furthermore being arranged to determine the thermal resistance from the type of clothes thus measured.

The second datum (MET) representative of the metabolic activity of the passenger depends on a heart rate HR of the passenger, which is especially measured by the camera 3, as may be seen in FIG. 3.

This camera 3 is arranged to observe changes in the color of the face of the passenger due to the movement of blood under the skin of the face, and the system measures the heart rate based on these images.

The second datum (MET) representative of the metabolic activity of the passenger is dependent on a physical characteristic of the passenger, which is measured by the camera 6 with a view to determining, by image processing, physical characteristics PC of the passenger, especially his sex, age, size and volume, and indirectly his weight.

The second datum MET representative of the metabolic activity of the passenger corresponds to a thermal power per unit area PS produced by the passenger, which is deduced using the datum PC.

A plurality of data (MET) representative of the metabolic activity of the passenger are used.

The system 1 is arranged to, from the temperatures of the walls and/or window, which are measured by the infrared dome 4, to compute the radiative temperature of a plurality of parts of the body of the passenger, such as his head Z1, chest Z2, back Z3, legs Z4, feet Z5, arms Z6 and hands Z7, as shown in FIG. 3.

The system 1 is arranged to estimate the temperature of the air making contact with a part of the body of the passenger, and especially a plurality of parts of the body of the passenger, especially his head, chest, back, legs, calves, feet, and/or arms, especially based on the power of an air blower and/or of the distribution of the HVAC and/or of the temperature of the blown air and of the temperature of the passenger compartment, especially on the basis of charts.

The system 1 is arranged, on the basis of the HVAC distribution and/or of the power of the air blower, to estimate, especially using charts, the speed of the air making contact with one part or a plurality of parts of the body of the passenger.

These temperatures and/or speeds TV are used to compute the third datum representative of the thermal environment of the passenger in the passenger compartment.

The system 1 is arranged to estimate the total thermal power (P_tot_theoritical) exchanged by the passenger with his environment by estimating the thermal power exchanged by each part of his body, especially his head, chest, back, legs, calves, feet and arms. This total exchanged thermal power (P_tot_theoretical) is dependent on the data Clo, Met and PS.

Specifically, the exchanged powers are dependent on the local air speed, on the local air temperature, on the local radiative temperature, on the area of the passengers, on the clothing level (Clo) of the passenger, and on the second datum (MET) representative of the metabolic activity of the passenger.

The system 1 is arranged to compare the total thermal power (P_tot_theoretical) exchanged with the environment with the theoretical power generated by the metabolism of the passengers, and, by multiplying this power difference by a coefficient, to determine a value of the thermal comfort index (PMV).

According to one aspect of the invention, this model can then be used to estimate the instantaneous comfort of the passengers. Set points may also be defined for the thermal actuators in order to ensure passenger comfort. Adjustment of the thermal system is thus personalized.

The method is able to take into account heat exchange by respiration, sweating and perspiration, which depends on the ambient humidity and temperature and on metabolism, to estimate a comfort index.

Metabolic activity is determined depending on the date and/or time, sex, age and other personal characteristics of the passenger, and on the datum or knowledge of their current or previous activities.

The control unit 2 is furthermore arranged to:
acquire the first datum (Clo) representative of the clothing level of a passenger in the passenger compartment and/or the second datum (MET) representative of the metabolic activity of the passenger,
acquire a parameter relative to a thermal-comfort state, this parameter possibly taking at least two extreme values, one of the values being associated with a calm state and the other of the values being associated with a dynamic state,
manage the air-conditioning device 10 to deliver treated air with a flow rate that is dependent on this parameter, this flow rate being, for a given clothing level and/or level of metabolic activity, lower in the case where the parameter is associated with a calm state and higher in the case where the parameter is associated with a dynamic state.

The system 1 is arranged to allow the temperature level generated by various actuators of the air-conditioning device to be automatically adjusted, machine learning and/or gradual calibration of the profile and preferences of the user being employed to this end.

The system 1 is arranged to determine a type of air distribution and the ventilation level provided by the air-conditioning device, especially depending on the use context, on the state of the passenger and on the ambient temperature.

The system 1 is arranged so that the first datum (Clo) representative of the clothing level of a passenger in the passenger compartment and/or the second datum (MET) representative of the metabolic activity of the passenger are used to set thermal want in light of the current state of the passenger (i.e. for example whether he is experiencing a physical or cognitive stress).

The system is arranged to store in memory and/or acquire at least one of the following elements:

a user profile,
at least one contextual element such as the first datum (Clo) representative of the clothing level of a passenger in the passenger compartment and/or the second datum (MET) representative of the metabolic activity of the passenger,
a parameter representative of a thermal-comfort state.

As illustrated in FIG. 4, the system comprises a member 40 for adjusting the heat felt by the passenger, especially of “Colder/Hotter” type, in order to allow the user, by requesting more or less felt heat via this adjusting member, to contribute to the machine learning or, for an occasional user, this adjusting member especially being connected to the control device.

The system 1 is arranged to control sensors and/or actuators used to ensure the comfort of the one or more passengers in the vehicle, on the basis of the following parameters:
the parameter related to the comfort state, which is tailored to the one or more passengers,
a first datum (Clo) representative of the clothing level of a passenger in the passenger compartment and/or a second datum (MET) representative of the metabolic activity of the passenger,
at least one parameter representative of the profile of the passenger.

As illustrated in FIG. 4, the system 1 comprises a device 40 for interfacing between a thermal management system such as described above and a passenger of the vehicle, this interfacing device comprising:
an adjusting member 51, especially a touch button, arranged to permit the passenger to adjust the first datum (Clo) representative of the clothing level of a passenger in the passenger compartment
an adjusting member 52, especially a touch button, arranged to permit the passenger to adjust the second datum (MET) representative of the metabolic activity of the passenger,
a member 53 for adjusting the parameter relative to a thermal-comfort state.

According to one aspect of the invention, the system 1 is arranged so that the above parameters are freely selectable by the user, depending on his preferences or the context of use of the vehicle, or are automatically proposed by the comfort-control system, via knowledge of the user profile, learning of his habits or preferences, or processing of information delivered by sensors.

The system 1 is arranged to automatically control the above parameters while allowing the user, at any time, to modify one or more of these parameters, whether to indicate to the system an error in the evaluation of the thermal state of the person (for example his clothing and/or his metabolism) and/or an error in the evaluation of his want for thermal comfort (for example the comfort style, the potential correction of the temperature level once the thermal state is known).

According to one aspect of the invention, the comfort-control device is arranged to enrich and/or update a knowledge base, depending on modifications made by the passenger, with a learning software package aiming to improve the detection or prediction of the state and of the expectations of the passenger in the course of future uses of the control device.

According to one aspect of the invention, in winter, a comfort of “calm” type is associated with increased use of radiative heating (higher radiant-panel temperatures) and a decreased use of convective heating (decreased air flow rate and/or temperature). In contrast, a “dynamic” comfort is associated with an increased use of hot air, firstly to the feet and then to the chest and face in “very dynamic” mode for example.

According to one aspect of the invention, a comfort of “calm” type is associated with a decreased use of air speeds in the vicinity of the body of the passenger, this being achieved by privileging air outlets of “feet” and/or “defrost” type. A “dynamic” comfort is associated with an increase in the air speed perceived by the body and in particular by the chest and face, this especially being achieved by prioritizing dashboard fans, and preferably, in “highly dynamic” mode, by using ventilation nozzles in the pillars.

According to one aspect of the invention, the datum with respect to clothing level and metabolic state is enough to determine the temperature to be achieved by the various actuators (air temperature, radiant panels, etc.), provided that the profile and preferences of the person have been apprised.

According to one aspect of the invention, the system is arranged to allow the passenger to choose a “hotter/colder” temperature preference with respect to the automatically proposed adjustments. This adjustment is considered to be optional, because this adjustment is used only in learning mode or by an occasional user, the profile of whom is unknown. In particular, access to this adjustment is not a substitute for the automatic account that is taken of the state of the user.

The temperature preference may especially be expressed in values of: −2° C./+1° C. etc., or qualitatively: “definitely colder”, “colder”, “slightly colder”, “slightly hotter”, etc. with an adjustment limited to a small set of values, typically −3/+3.

According to one aspect of the invention, the default adjustment, which is especially a neutral adjustment, corresponds to the average expectations estimated for the targeted user group, depending on climatic conditions and on the comfort style and state of the users.

According to one aspect of the invention, the system is arranged to generate information representative of the confidence level attributed to the knowledge bases and/or models used to evaluate the state and the thermal want of the user.

According to one aspect of the invention, this information representative of the confidence level is generated in the form of the display of an icon or any other graphical or text element, or any other communication element.

According to one aspect of the invention, this information representative of the confidence level is arranged to establish a dialog between the vehicle and the passenger, in order to show both:
the ability of the control system to identify and propose comfort-management options that will become enriched via a learning process in the course of use,
the need and ability of the system to learn and improve by virtue of user feedback and requests.

This information representative of confidence level may be of two sorts, as follows:
the system highlights that it thinks that a specific thermal want or state has been detected and is in a position to provide the passenger with a solution,
the system lacks information and requests the passenger to apprise or confirm certain parameters.

According to one exemplary embodiment of the invention, the system is arranged to generate:
an activation element for activating at least one automatic comfort-management mode. It is possible to provide two automatic comfort-management modes, one privileging comfort without compromise, the other privileging a decrease in power consumption.

According to one exemplary embodiment of the invention, as soon as the user modifies at least one of the parameters, the system switches to “manual” management mode until the activation of one of the automatic modes is again triggered.

According to one exemplary embodiment of the invention, the system is arranged to generate:
an actuation element for actuating a safety mode for demisting and defrosting the windshield,
where appropriate, a second activation element for managing the degree of humidity in the passenger compartment,
the display of key information apprising of the comfort-management configuration, with, non-exhaustively:

the identity of the person or of the user profile with which the current comfort-management model is associated. This identity will possibly be automatically recognized or selected/modified if required,

the exterior ambient temperature,

the temperature perceived by the user, which is a fictional temperature computed from measured real temperature differences and which characterizes the overall equivalent temperature of an environment (air and walls) that would give the same average thermal sensation in calm air,

the power consumption induced by the comfort-management configuration, which may advantageously be expressed in two ways:
the operating range lost with respect to a reference operating range, for example the WLTC operating range, or the operating range induced in this reference cycle,
a color code, or any other graphical or textual element, that expresses whether the configuration and choices of the comfort parameters are eco-responsible, or in other words whether they allow power consumption to be minimized without substantially degrading comfort. For example, in winter, the fact of being warmly clothed and favoring radiative comfort will be positively appraised. In slimmer, a light outfit and the use of the dynamic mode with nozzles nearby will also be positively appraised.

In both cases, the display modalities and choices aim to raise user awareness of the consequences of their choices on the consumption and the operating range of the vehicle, in a neutral and constant reference system that allows the consequences of the climatic conditions and comfort options to be better appreciated.

Yet another subject of the invention is a device for interfacing between a thermal management system arranged to manage and control the interactions between a passenger and the thermal management system of a motor vehicle, this device being arranged to:

allow the user to be informed of various information items describing the configuration, the state and the operating parameters of the thermal-comfort management system,
allow the user to configure, parameterize and activate various functions of the thermal-comfort management system,
allow at least three parameters defining the configuration and the adjustment of the thermal-comfort management system to be adjusted for an identified person, namely:
   a parameter relating to the choice of a style of thermal comfort, of the type “gentler” or “more dynamic”
   two parameters relating to the description of the state of the user:
      a clothing level
      a level of metabolic activity

1. A thermal management system for a motor-vehicle passenger compartment, this system comprising:
an air-conditioning device comprising at least one outlet for heat-treated air, and a HVAC; and
a control unit arranged to:
acquire a first datum representative of the clothing level of a passenger in the passenger compartment and/or a second datum representative of the metabolic activity of the passenger,
acquire a parameter relative to a thermal-comfort state, the parameter being one of at least two extreme values including a calm state and a dynamic state,
manage the air-conditioning device to deliver treated air with a flow rate that is dependent on the parameter,
the flow rate being, for a given clothing level and/or metabolic activity, lower in the case where the parameter is associated with the calm state and higher in the case where the parameter is associated with the dynamic state.

2. The system as claimed in claim 1, wherein the system is configured to allow the temperature level generated by various actuators of the air-conditioning device to be automatically adjusted using machine learning and/or gradual calibration of a profile and preferences of a user.

3. The system as claimed in claim 1, wherein the system is configured to store in memory and/or acquire at least one selected from the group consisting of: a user profile, at least one contextual element such as the first datum representative of the clothing level of a passenger in the passenger compartment and/or the second datum representative of the metabolic activity of the passenger, a parameter representative of a thermal-comfort state.

4. The system as claimed in claim 1, further comprising: a member for adjusting the heat felt by the passenger, of “Colder/Hotter” type, in order to allow the user, by requesting more or less felt heat via this adjusting member, to contribute to the machine learning or, and wherein for an occasional user, the adjusting member is connected to the control device.

5. The system as claimed in claim 2, wherein the parameters are freely selectable by the user, depending on the preferences or a context of use of the vehicle, or wherein the parameters are automatically proposed by the system, via knowledge of the user profile, learning of user habits or preferences, or processing of information delivered by sensors.

6. The system as claimed in claim 2, wherein the system to automatically controls the parameters while allowing the user, at any time, to modify one or more of the parameters, whether to indicate to the system an error in the evaluation of the thermal state of the person and/or an error in the evaluation of the user's want for thermal comfort.

7. The system as claimed in claim 2, the system being configured to enrich and/or update a knowledge base, depending on modifications made by the user, with a learning software configured to improve the detection or prediction of the state and of the expectations of the user in a course of future uses of the system.

8. The system as claimed in claim 1, wherein the system is configured to generate information representative of the confidence level attributed to the knowledge bases and/or models used to evaluate the state and the thermal want of the user.

9. A device for interfacing between a thermal management system of a motor vehicle passenger compartment as claimed in claim 1 and a passenger of the vehicle, the interfacing device comprising:
an adjusting member comprising a touch button, arranged to permit the passenger to adjust the first datum representative of the clothing level of a passenger in the passenger compartment and/or the second datum representative of the metabolic activity of the passenger; and
a member for adjusting a parameter relative to a thermal-comfort state of the passenger compartment.

10. A device for interfacing between a thermal management system arranged to manage and control the interactions between a passenger and a thermal management system of a motor vehicle, the device being arranged to:
allow the user to be informed of a configuration, a state and operating parameters of the thermal-comfort management system,
allow the user to configure, parameterize and activate various functions of the thermal-comfort management system, and
allow at least three parameters defining configuration and adjustment of the thermal-comfort management system to be adjusted for an identified person, namely:
a parameter relating to the choice of a style of thermal comfort, of the type “gentler” or “more dynamic,” and two parameters relating to the description of the state of the user: a clothing level and a level of metabolic activity.

11. A thermal management method for a motor-vehicle passenger compartment, using an air-conditioning device comprising at least one outlet for heat-treated air, the air-conditioning device especially comprising a HVAC, and the method comprising:
acquiring a first datum representative of the clothing level of a passenger in the passenger compartment and/or a second datum representative of the metabolic activity of the passenger;
acquiring a parameter relative to a thermal-comfort state, the parameter taking at least two extreme values: a calm state and a dynamic state; and
managing the air-conditioning device to deliver treated air with a flow rate that is dependent on the parameter, the flow rate being, for a given clothing level and/or level of metabolic activity, lower in the case where the parameter is associated with the calm state and higher in the case where the parameter is associated with the dynamic state.
